(19) United States
(12) Patent Application Publication
(10) Pub. No.: US 2026/0086228 A1
(43) Pub. Date: Mar. 26, 2026

(54) WIRELESS BASE STATION DEPLOYMENT FOR TARGET MAPPING

(71) Applicant: Infinitus Holdings Inc., Penn Valley, PA (US)

(72) Inventors: Joshua Ian Cohen, Penn Valley, PA (US); John Cronin, Jericho, VT (US)

(21) Appl. No.: 18/895,234

(22) Filed: Sep. 24, 2024

(51) Int. Cl. G01S 13/90; F41G 7/22; G01S 5/04; G01S 13/86

(52) U.S. Cl. CPC G01S 13/90; F41G 7/2206; G01S 5/04; G01S 13/867

(57) ABSTRACT

A method includes receiving, via a phased antenna array of a first wireless base station, signals from one or more signal sources in an environment; determining, via a signal processor based on the signals, a location of each of the one or more signal sources in the environment relative to the phased antenna array; determining a position of the first wireless base station in the environment; transmitting, via the phased antenna array, radar signals into the environment; receiving, via the phased antenna array, reflected signals from the environment; determining, using SAR, information about at least one of a distance and a movement of one or more physical objects in the environment; collecting the information about the at least one of the distance and the movement of the one or more physical objects in the environment from the SAR; and generating a 3D spatial map of the environment using the information.

### FIELD OF THE DISCLOSURE

The present disclosure is generally related to systems and methods of 3D mapping using a phased array.

### BACKGROUND

Identifying key signals in challenging environments is essential for effective planning and operations. For instance, imagine a scenario where a major earthquake has struck a densely populated urban area. First responders need to locate survivors, communication points, and potential hazards amid the rubble. Long-range signal detection and visual identification are often unreliable due to debris and signal interference. Close-range detection provides a more accurate map of signals, which is beneficial in such situations.

First responders equipped with advanced technology can get close enough to accurately map these signals, but navigating through unstable structures poses significant risks to their safety. While unmanned drones could be used, they may struggle to navigate through narrow or obstructed spaces within collapsed buildings and can be easily detected and damaged, leading to higher operational costs and delays.

There is a need for a cost-effective and safe technique for first responders to map environments and locate critical signals. This method should minimize risks to human life and allow for easy retrieval and redeployment of the equipment, ensuring timely and efficient disaster response.

### SUMMARY

The present disclosure solves the problems of conventional approaches by providing cost-effective techniques for first responders to map environments and locate critical signals.

According to one aspect, a system comprises a first wireless base station including a phased antenna array configured to receive signals from one or more signal sources in an environment. The system also includes a signal processing module to determine, based on the signals, a location of each of the one or more signal sources in the environment relative to the phased antenna array. The system further includes a position module configured to determine a position of the first wireless base station in the environment. In addition, the system includes a physical location detection apparatus including a synthetic aperture radar (SAR), the physical location detection apparatus configured to transmit, via the phased antenna array, radar signals into the environment; and receive, via the phased antenna array, reflected signals from the environment including information about at least one of a distance and a movement of one or more physical objects in the environment. The system also includes a mapping module configured to collect the information about the at least one of the distance and the movement of the one or more physical objects in the environment from the physical location detection apparatus and generate a three-dimensional (3D) spatial map of the environment using the information. Additionally, the system includes a data fusion module configured to fuse the 3D spatial map with the location of each of the one or more signal sources to produce a first fused map locating the one or more physical objects and the one or more signal sources in the environment.

In some embodiments, the system further includes a mesh module configured to connect the first wireless base station and one or more additional wireless base stations via a mesh network by which the first wireless base station and the one or more additional wireless base stations able to share data and relay signals.

In some embodiments, the mesh module is further configured to establish a network hierarchy including selection of a primary wireless base station from the first wireless base station and the one or more additional wireless base stations and establish one or more data routes through the mesh network to a target wireless base station and/or to a destination system.

In some embodiments, the method further includes a stitching module configured to combine the first fused map with one or more additional fused maps generated by the one or more additional wireless base stations to generate a cohesive map capable of being shared with a destination system.

In some embodiments, the method further includes a target module configured to identify one or more targets by comparing signal data received by the phased antenna array with a signal database including known targets or types of targets and tag identified targets of the one or more targets in the first fused map.

In some embodiments, the signal processing module is configured the location of each of the one or more signal sources using at least one of an Angle of Arrival (AoA) measurement, a Kalman filter, a Joint Probabilistic Data Association (JPDA) operation, and/or a Multiple Signal Classification (MUSIC) algorithm.

In some embodiments, the signal processing module is configured to determine the location of each of the one or more signal sources by triangulation and/or trilateration.

In some embodiments, the signal processing module operates in an active mode by initially pinging the one or more signal sources via the phased antenna array before detecting the signals; or the signal processing module operates in a passive mode by detecting the signals without first pinging the one or more signal sources.

In some embodiments, the position module is configured to use one or more enhancement sensors to determine the position of the first wireless base station.

In some embodiments, the physical location detection apparatus further includes one or more cameras and/or sensors, and wherein data from the one or more cameras and/or sensors is used together with the SAR in generating the 3D spatial map.

According to another aspect, a method includes receiving, via a phased antenna array of a first wireless base station, signals from one or more signal sources in an environment. The method also includes determining, via a signal processor based on the signals, a location of each of the one or more signal sources in the environment relative to the phased antenna array. The system further includes determining a position of the first wireless base station in the environment. Additionally, the method includes transmitting, via the phased antenna array, radar signals into the environment. The method also includes receiving, via the phased antenna array, reflected signals from the environment. In addition, the method further includes determining, using a synthetic aperture radar (SAR), information about at least one of a distance and a movement of one or more physical objects in the environment. Further, the method includes collecting the information about the at least one of the distance and the movement of the one or more physical objects in the environment from the SAR. Additionally, the method includes generating a three-dimensional (3D) spatial map of the environment using the information. The method also includes fusing the 3D spatial map with the location of each of the one or more signal sources to produce a first fused map locating the one or more physical objects and the one or more signal sources in the environment.

In some embodiments, the method further includes connecting the first wireless base station and one or more additional wireless base stations via a mesh network by which the first wireless base station and the one or more additional wireless base stations able to share data and relay signals.

In some embodiments, connecting includes establishing a network hierarchy including selection of a primary wireless base station from the first wireless base station and the one or more additional wireless base stations and establishing one or more data routes through the mesh network to a target wireless base station and/or to a destination system.

In some embodiments, the method further includes combining the first fused map with one or more additional fused maps generated by the one or more additional wireless base stations to generate a cohesive map capable of being shared with a destination system.

In some embodiments, the method further includes identifying one or more targets by comparing signal data received by the phased antenna array with a signal database including known targets or types of targets and tagging identified targets of the one or more targets in the first fused map.

In some embodiments, determining the location of each of the one or more signal sources in the environment relative to the phased antenna array includes using at least one of an Angle of Arrival (AoA) measurement, a Kalman filter, a Joint Probabilistic Data Association (JPDA) operation, and/or a Multiple Signal Classification (MUSIC) algorithm.

In some embodiments, determining the location of each of the one or more signal sources in the environment relative to the phased antenna array includes determine the location of each of the one or more signal sources by triangulation and/or trilateration.

In some embodiments, receiving includes actively pinging the one or more signal sources via the phased antenna array before detecting the signals or passively detecting the signals without first pinging the one or more signal sources.

In some embodiments, determining the position of the first wireless base station includes using one or more of enhancement sensors to determine the position of the first wireless base station.

In some embodiments, generating the 3D spatial map includes using one or more cameras and/or sensors together with the SAR to generate the 3D spatial map.

### BRIEF DESCRIPTION OF THE DRAWINGS

FIG. 1 is a schematic diagram of a phased array tracking system, according to an embodiment.

FIG. 2 is a flowchart of a method performed by a Base Module, according to an embodiment.

FIG. 3 is a flowchart of a method performed by a Signal Processing Module, according to an embodiment.

FIG. 4 is a flowchart of a method performed by a Position Module, according to an embodiment.

FIG. 5 is a flowchart of a method performed by a Mapping Module, according to an embodiment.

FIG. 6: Illustrates a Data Fusion Module, according to an embodiment.

FIG. 7 is a flowchart of a method performed by a Mesh Module, according to an embodiment.

FIG. 8 is a flowchart of a method performed by a Stitching Module, according to an embodiment.

FIG. 9 is a flowchart of a method performed by a Target Module, according to an embodiment.

FIG. 10 is a flowchart of a method performed by a Signal Database, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

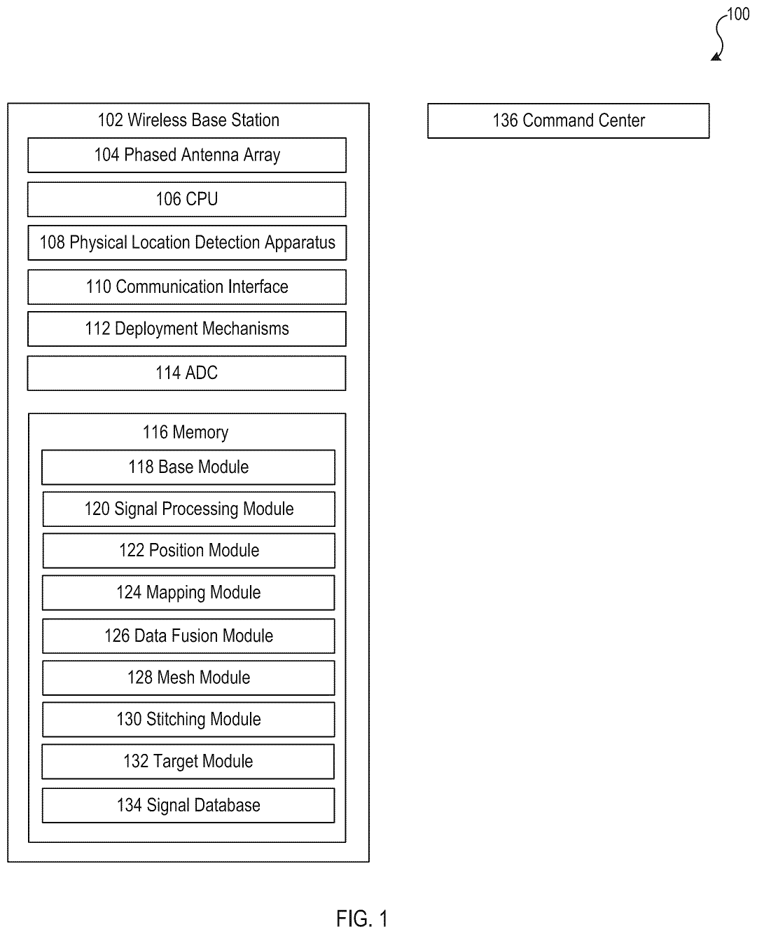

FIG. 1 is a schematic illustration of a phased array tracking system 100. The system 100 may include a wireless base station 102, which may track the location of one or more signal sources. The wireless base station 102 may also be a type of wireless router that allows for a Bluetooth, cellular, or other type of signal frequency connection or broadcast. In one embodiment the wireless base station 102 may be for military grade synthetic aperture radar signals. The wireless base station 102 may include a phased antenna array 104 comprised of multiple individual antennas, each capable of transmitting and/or receiving electromagnetic signals. The wireless base station 102 receives signals from one or more sources using the phased antenna array 104. It triangulates the location of the source using an angle of arrival (AoA) calculation based on the difference in phase and time of the received signals. The wireless base station 102 may have active and passive functionality, which may be separate modes or may both function simultaneously. Passive functionality may refer to only receiving signals from sources (e.g., without pinging the sources), whereas active functionality may refer to transmitting to a device (e.g., pinging the device) in order to elicit a response. Achieving centimeter-level accuracy in 3D mapping is helpful for applications that benefit from precise positioning and spatial awareness. The system 100 is designed to provide this high level of precision, ensuring that positioning can be accurately determined within centimeter-level tolerances, or better, in 3D space. To enhance the capabilities of 3D mapping, the data obtained from the wireless base station 102 can be integrated with various other 3D mapping technologies. For instance, synthetic aperture radar (SAR) can be utilized to offer additional spatial data, leveraging its ability to produce high-resolution images and detect changes over time. Incorporating camera-based systems can provide visual context and details that may not be captured by the phased antenna array alone. Ultrasound technology can also be employed, especially in environments where optical or radar-based systems might face challenges, such as underwater or in densely cluttered areas. Additionally, LIDAR technology can be integrated to measure distances by illuminating targets with laser light and measuring the reflection with a sensor, which is useful in applications like autonomous vehicles and topographic mapping. Combining these technologies allows for a more comprehensive 3D mapping process, enhancing accuracy and applicability across various fields. For example, in urban planning, combining phased array data with LIDAR can create detailed city models. In agriculture, integrating data from SAR and drones can help in precise crop monitoring and land use planning. In search and rescue operations, combining ultrasound with phased array data can assist in locating individuals in challenging environments. This approach ensures that the 3D mapping solution is effective in a wide range of scenarios, meeting the diverse needs of different industries and applications. The wireless base station 102 may be attached to the tip of projectile (such as a missile) or other ballistic weapon. The wireless base station 102 may guide the projectile to its target, similar to an anti-radiation projectile. The projectile tipped with the wireless base station 102 may guide multiple other projectiles in a swarm to the same location or to other locations. One or more wireless base stations 102 may be deployed via airdrop or fired into the battlefield in order to guide a projectile to a target. One or more wireless base stations 102 may be either airdropped or fired into the battlefield and locked onto a geospatial non-transmitting target within range. When a projectile or multiple projectiles come within range of one or more wireless base stations 102, they may guide the projectile to the non-transmitting location within range of the wireless base stations. Wireless base stations 102 may function in a distributed capacity, including distributed with one or more projectiles, aircraft, vehicles, etc. nearby.

The system 100 may further include a phased antenna array 104, which may be an array of antennas that receive and/or transmit at different phases. This phased array 104 may include any combination of receiver antennas, transmitter antennas, and antennas capable of both receiving and transmitting signals, thereby providing versatile communication capabilities. The phased antenna array 104 may include at least one antenna capable of transmission for the active functions of the wireless base station 102, such as beamforming, signal amplification, and directed communication. The phased antenna array 104 may also include at least two antennas capable of receiving for the triangulation functions of the wireless base station 102. These receiving antennas facilitate precise location determination of signal sources through techniques such as angle of arrival (AoA) estimation. The antennas may be arranged in a specific geometric configuration, such as linear, circular, or planar arrays, and electronically connected such that their individual signal phases and amplitudes can be controlled. This electronic control enables the phased array to dynamically steer the beam direction, enhance signal strength, and reduce interference from unwanted sources. The phased antenna array 104 may incorporate signal processing algorithms to optimize its performance. These algorithms may include adaptive beamforming, which adjusts the phase and amplitude of each antenna element to maximize signal reception from desired directions while minimizing noise and interference. The phased antenna array 104 may also support multiple-input multiple-output (MIMO) technology, allowing simultaneous transmission and reception of multiple data streams, thereby increasing the overall data throughput and reliability of the system 100. The phased antenna array 104 may be integrated with a control unit that monitors and adjusts the operational parameters of each antenna element in real-time. This control unit may utilize feedback mechanisms to dynamically adapt to changing environmental conditions and signal propagation characteristics, ensuring optimal performance under various scenarios. The integration of these features within the phased antenna array 104 enhances the system's capability to provide robust and efficient communication and precise triangulation of signal sources. The phased antenna array 104 may include a low noise amplifier (LNA) to amplify weak incoming signals from multiple antennas while minimizing noise. The LNA may include a number of channels which each correspond to a specific antenna in the phased array, enhancing sensitivity and accuracy. The phased antenna array 104 may be able to transmit and receive over a very wide range of frequencies, especially long-range frequencies. The phased antenna array 104 may be an active electronically scanned array (AESA), which may be a computer-controlled antenna array in which the signal can be electronically steered to point in different directions without moving the antenna. The phased antenna array 104 may be made from advanced materials, such as graphene or metamaterials, so as to deliver the increased sensitivity needed for certain applications. Examples of metamaterials may include negative index metamaterials, chiral metamaterials, plasmonic metamaterials, photonic metamaterials, graphene-based nanostructures, or any other metamaterials known in the art.

The system 100 may further include a computer processing unit (CPU) 106, which may be configured to decode and execute any instructions received from one or more other electronic devices or server(s). The CPU 106 may include one or more general-purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The CPU 106 may be configured to execute one or more computer-readable program instructions, such as program instructions, to carry out any of the functions described in this description. The CPU 106 may be a GPU such as those produced by Nvidia®.

The system 100 may further include a physical location detection apparatus 108, which may include Synthetic Aperture Radar (SAR), cameras, or other sensors to accurately map the environment in 3D. Synthetic Aperture Radar (SAR) employs radar signal transmission and reception to generate high-resolution images of the environment. SAR transmits radar pulses towards the target area and captures the reflected signals. By analyzing the time delay and phase shifts of these signals, the distance to various points in the environment is calculated. SAR synthesizes a larger aperture by moving the radar sensor over a distance, such as on a satellite, aircraft, or drone, thereby enhancing resolution and detail beyond the capabilities of a physical antenna of the same size. Techniques such as Interferometric SAR (InSAR) and Tomographic SAR (TomoSAR) further enhance the system's ability to map 3D space. InSAR involves capturing multiple SAR images from slightly different positions and analyzing phase differences to extract precise elevation data, creating detailed 3D terrain models. TomoSAR uses multiple SAR images from various angles to reconstruct the 3D structure of complex targets, such as urban environments, similar to medical tomography. The system 100 may also utilize various types of cameras equipped with depth-sensing capabilities to map 3D space. These include stereo cameras, Time-of-Flight (ToF) cameras, structured light cameras, and LIDAR systems. The integration of SAR and camera data enhances the system's ability to produce detailed and accurate 3D maps. The data fusion process combines the strengths of both technologies: SAR provides precise distance measurements and the ability to penetrate obstructions like foliage or clouds. At the same time, cameras offer high-resolution texture and detail. This combination allows the system 100 to create multi-resolution models, with SAR providing large-scale topographic mapping and cameras offering detailed local 3D reconstruction. Additionally, cross-validation techniques may be employed to refine and validate the 3D models by cross-referencing data from SAR and cameras, improving overall accuracy and reducing errors. This holistic approach ensures that the physical location detection apparatus 108 can deliver comprehensive and precise 3D environmental mapping suitable for a wide range of applications, from urban planning and environmental monitoring to virtual and augmented reality experiences. In some embodiments, the physical location detection apparatus 108 may be able to identify targets without any additional signal data. This is useful for identifying non-transmitting targets.

The system 100 may further include a communication interface 110, which may be a set of hardware and/or software components that facilitate the exchange of data between different systems, devices, or components. The communication interface 110 serves as the conduit through which data is transmitted, received, and interpreted, ensuring seamless communication between the wireless base stations 102 and the command center 136. The communication interface 110 may be able to transmit and receive at the same time. The communication interface 110 may use frequency hopping, which may utilize AI algorithms, in order to remain covert while behind enemy lines.

The system 100 may further include one or more deployment mechanisms 112, which may facilitate the deployment of the wireless base station 102. Deployment mechanisms 112 may include mechanisms for deploying the probe from the plane or drone, such as latches, clips, cables, etc. Deployment mechanisms 112 may include stabilization systems, such as fins, gyroscopes, or other stabilization mechanisms to ensure the wireless base station 102 maintains the preferred orientation during descent. Deployment mechanisms 112 may include descent mechanisms, such as parachutes, airbags, and shock absorbers. Deployment mechanisms 112 may include recovery mechanisms, such as a GPS beacon. Deployment mechanisms 112 may include environmental protections to protect instruments from harsh environmental conditions and to maintain the internal conditions of the wireless base station 102 within operational limits, especially in extreme temperatures. Deployment mechanisms 112 may include any other mechanism that facilitates the deployment of one or more wireless base stations 102.

The system 100 may further include an analog-to-digital converter (ADC) 114, which may be configured to convert the received signals from an analog signal into a digital processor readable format.

The system 100 may further include memory 116, which may include but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or another type of media/machine-readable medium suitable for storing electronic instructions. The memory may include modules implemented as a program.

The system 100 may further include a base module 118, which may collect received signal data from the phased antenna array 104. The base module 118 may initiate the signal processing module 120 and send in the signal data. The base module 118 may receive processed signal data from the signal processing module 120. The base module 118 may initiate the position module 122. The base module 118 may receive the position of the wireless base station 102 from the position module 122. The base module 118 may initiate the mapping module 124. The base module 118 may receive a 3D map of the environment from the mapping module 124. The base module 118 may initiate the data fusion module 126. The base module 118 may receive fused map data from the data fusion module 126. The base module 118 may determine if there are any other wireless base stations 102 in range. If there are other wireless base stations 102, the base module 118 may initiate the mesh module 128. The base module 118 may initiate the stitching module 130. The base module 118 may receive combined map data from the stitching module 130. The base module 118 may initiate the target module 132 and send in the fused map data or combined fused map data. The base module 118 may receive tagged map data from the target module 132. The base module 118 may send the tagged map data to the command center 136. If a mesh network of wireless base stations 102 has been established by the mesh module 128, then the tagged map data may be sent to another wireless base station 102 to be relayed to the command center 136.

The system 100 may further include a signal processing module 120, which may process the signals received by the phased antenna array 104 in order to locate the source of the signal in 3-dimensional space. The signal processing module 120 may utilize sophisticated computational techniques such as Kalman filters and joint probabilistic data association to accurately estimate device locations and track their movements while maintaining synchronization among multiple antennas for precise triangulation. The signal processing module 120 may utilize a sub nanosecond clock and a high-speed power meter for detecting the small differences in time between receiving a signal at two or more receiver antennas.

The system 100 may further include a position module 122, which may determine the position of the wireless base station 102. The position module 122 may use one or more enhancement sensors, such as, without limitation, GPS devices, accelerometers, gyroscopes, magnetometers, barometric pressure sensors, speed pulse sensors, Inertial Measurement Units (IMUs), compasses anemometers, cameras, altimeters, orthogonal rate-gyroscopes, orthogonal accelerometers, MEMS gyroscopes, angular accelerometers, linear accelerometers, linear accelerometers on a gimballed gyrostabilized platform, ring laser gyroscopes, fibre optic gyroscopes, hemispherical resonator gyroscopes, vibrating structure gyroscopes, quartz rate sensors, magnetohydrodynamic sensors, pendular accelerometers, Timing & Inertial Measurement Unit (TIMU), and/or the tracking data from the signal processing module 120, to determine the position of the wireless base station 102.

The system 100 may further include a mapping module 124, which may collect and process data from the physical location detection apparatus 108 to create a 3D map of the environment.

The system 100 may further include a data fusion module 126, which may fuse the 3D mapping data with processed signal data to enhance map accuracy. This creates a fused map with both the locations of physical objects and signal sources.

The system 100 may further include a mesh module 128, which may facilitate the connection of multiple wireless base stations 102 into a mesh network. The mesh module 128 may allow wireless base stations 102 to share data and relay signals, allowing data to travel along the mesh network to reach a destination such as a command center 136.

The system 100 may further include a stitching module 130, which may combine data from multiple wireless base stations 102 to create a cohesive map. The stitching module 130 may use a consensus algorithm to verify that all connected wireless base stations 102 agree on the created map.

The system 100 may further include a target module 132, which may identify targets by comparing the signal data to the signal database 134. The identified targets may then be tagged as such in the signal data.

The system 100 may further include a signal database 134, which may contain signals for known targets or types of targets. Target types may refer to general assets that have an identifiable signal and would likely be tactical (e.g., military) targets, such as artillery, communications, vehicles, etc. Unique targets with unique signals may also be included in the signal database 134, such as the IP of an enemy commander's computer.

The system 100 may further include a command center 136, which may be a central location from which operations are directed and monitored. The command center 136 may serve as the hub for decision-making and coordination of activities, particularly during critical situations or complex operations. The command center may include at least one computer capable of receiving data from at least one wireless base station 102. This data is then used by humans and/or machines at the command center in order to make decisions. For example, a commander may use the data from the wireless base stations 102 to strategize an infantry mission in the scanned area. For another example, a targeting computer may use data from the wireless base stations 102 to launch a projectile at an identified target.

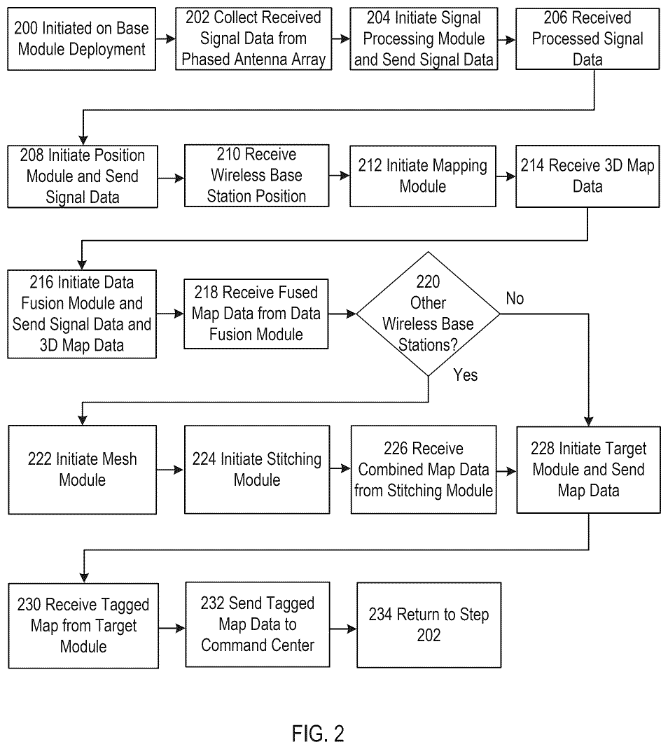

FIG. 2 illustrates an example operation of the base module 118. The base module 118 may be initiated at step 200 when the wireless base station 102 is powered on and/or activated. The base module 118 may collect at step 202 received signal data from the phased antenna array 104. Signal data may be data on signals received from one or more sources. Signal data may include the waveform of the signal, the time received, the intensity of the signal, the phase of the signal, or any other property of the signal. Each antenna of the phased antenna array 104 may provide unique signal data. The base module 118 may initiate at step 204 the signal processing module 120 and send in the signal data. The signal processing module 120 may process the signals received by the phased antenna array 104 in order to locate the source of the signal in 3-dimensional space. The signal processing module 120 may utilize sophisticated computational techniques such as Kalman filters and joint probabilistic data association to accurately estimate device locations and track their movements while maintaining synchronization among multiple antennas for precise triangulation. The signal processing module 120 may utilize a sub-nanosecond clock and a high-speed power meter for detecting the small differences in time between receiving a signal at two or more receiver antennas. The base module 118 may receive at step 206 processed signal data from the signal processing module 120. The signal data may include tracking data. This tracking data may include the calculated location of each signal source based on received signals. The data may also include metadata such as confidence level and margin of error. For example, the tracking data may include that a civilian device is at the coordinates (1348 cm, 804 cm, −52 cm) and a vehicle is at the coordinates (1145 m, 210 cm, −30 cm) where the origin (0,0,0) is the location of the wireless base station 102. The base module 118 may initiate at step 208, the position module 122. The position module 122 may determine the position of the wireless base station 102. The position module 122 may use GPS tracking, accelerometers, and/or the tracking data from the signal processing module 120 to determine the position of the wireless base station 102. The base module 118 may receive at step 210 the position of the wireless base station 102 from the position module 122. For example, the wireless base station 102 may be at the coordinates 34.4030662539572, −89.1316233216658, and at an altitude of 197 m. The base module 118 may initiate at step 212, the mapping module 124. The mapping module 124 may collect and process data from the physical location detection apparatus 108 to create a 3D map of the environment. The base module 118 may receive at step 214 a 3D map of the environment from the mapping module 124. This map data may show the locations of physical objects and terrain. The base module 118 may initiate at step 216, the data fusion module 126. The data fusion module 126 may fuse the 3D mapping data with processed signal data to enhance map accuracy. This creates a fused map with both the locations of physical objects and signal sources. The base module 118 may receive at step 218 fused map data from the data fusion module 126. The base module 118 may determine at step 220 if there are any other wireless base stations 102 in range. This may be determined by detecting other wireless base stations 102 in the signal data. If no other wireless base stations 102 are detected, the base module 118 may skip to step 228. If there are other wireless base stations 102, the base module 118 may initiate at step 222, the mesh module 128. The mesh module 128 may facilitate the connection of multiple wireless base stations 102 into a mesh network. The mesh module 128 may allow wireless base stations 102 to share data and relay signals. This allows data to travel along the mesh network to reach a destination such as a command center 136. The base module 118 may initiate at step 224, the stitching module 130. The stitching module 130 may combine data from the multiple wireless base stations 102 to create a combined map. The stitching module 130 may use a consensus algorithm to verify that all connected wireless base stations 102 agree on the created map. The base module 118 may receive at step 226 combined map data from the stitching module 130. Combined map data may refer to the combination of all fused map data from all wireless base stations 102 in the mesh network. The base module 118 may initiate at step 228 the target module 132 and send in the fused map data or combined fused map data. The target module 132 may identify targets by comparing the signal data to the signal database 134. The identified targets may then be tagged as such in the signal data. The base module 118 may receive at step 230 tagged map data from the target module 132. This refers to the fused map data or combined fused map data with additional data tags that identify targets. For example, the fused map data may have tracking data that indicates a signal source at (141 m, 257 m, −195 m) from the wireless base station 102. The target module 132 may recognize this signal as a vehicle and tag that signal in the data. The base module 118 may send at step 232 the tagged map data to the command center 136. If a mesh network of wireless base stations 102 has been established by the mesh module 128, then the tagged map data may be sent to another wireless base station 102 to be relayed to the command center 136. The base module 118 may return at step 234 to step 202. The base module 118 may continue to loop through these steps until the wireless base station 102 is deactivated.

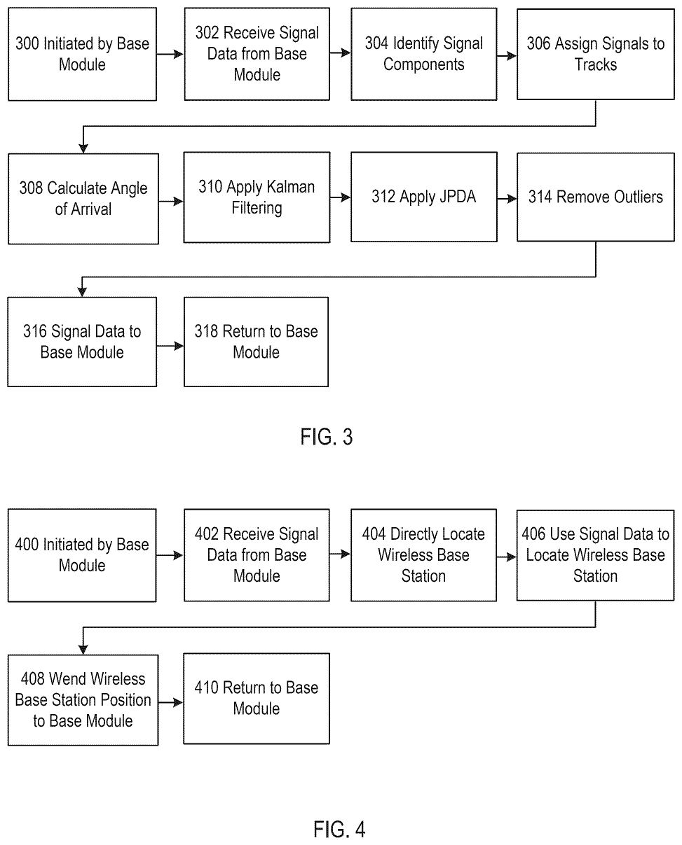

FIG. 3 illustrates an example operation of the signal processing module 120. The signal processing module 120 may be initiated at step 300 by the base module 118. The signal processing module 120 may receive at step 302 signal data from the base module 118. The signal processing module 120 may identify at step 304 the components of the received signals. Identifying the components of a signal, such as a Wi-Fi signal, may involve various techniques and tools. The signal processing module 120 may perform a frequency domain analysis using a Fast Fourier Transform (FFT). This converts the time-domain signal into its frequency components, allowing it to identify the carrier frequencies and any subcarriers. Tools like spectrum analyzers or SDR software can facilitate this process. The signal processing module 120 may determine the modulation scheme used. Wi-Fi signals typically use Orthogonal Frequency Division Multiplexing (OFDM). Analyzing the signal's modulation involves examining the changes in amplitude, frequency, or phase that encode the data. This can be done using constellation diagrams and demodulation algorithms. The signal processing module 120 may decode the higher-level protocol information. Wi-Fi signals conform to standards such as IEEE 802.11. Protocol analyzers or Wi-Fi sniffers can be used to interpret the protocol layers, extracting information such as MAC addresses, frame types, and payload data. Note that decryption of the data is not required for the data components to be identified in some embodiments. Cellular signals conform to standards such as LTE, GSM, and 5G. Protocol analyzers or cellular sniffers can be used to interpret the protocol layers, extracting information such as IMSI (International Mobile Subscriber Identity), cell tower identifiers, and data payload. Bluetooth signals typically use Gaussian Frequency Shift Keying (GFSK) and other modulation schemes like Phase Shift Keying (PSK) for enhanced data rates. Bluetooth signals conform to standards such as Bluetooth Core Specification. Protocol analyzers or Bluetooth sniffers can be used to interpret the protocol layers, extracting information such as device addresses, service records, and data payload. Note that, in some embodiments, decryption of the data is not required for the data components to be identified. Some signals, such as military signals, may have their components identified if the system 100 knows the modulation methods and protocols. These signals may be omitted from the public signal data. The signal processing module 120 may assign at step 306 the signals to tracks, associating new signals with existing tracks or creating new tracks. This involves analyzing the signal data and determining which signals correspond to which tracked signal source. The signal processing module 120 may use criteria such as signal strength, frequency, phase, identifying data, and timing information to match signals to known tracks. If a signal does not match any existing track, a new track is created. This step is beneficial for organizing the signal data into coherent tracks that can be further analyzed and monitored. The signal processing module 120 may calculate at step 308 the angle of arrival (AoA) for each signal using phase and time delay data. This involves determining the direction from which each signal is arriving relative to the phased array. The signal processing module 120 may use the phase differences and time delays between the signals received at different antennas to calculate the AoA. This step is helpful for understanding the spatial orientation of the signal sources and is a component in triangulating their positions. For example, the signal data indicates that a 2.4 GHz signal was received at antennas 1 and 2 of the phased antenna array 104. The signal was received 3 nanoseconds later at antenna 2, and the phase was shifted by 1 radian. Assume the antennas are 10 cm apart. The path difference (Δd) can be calculated using the time delay using the equation Δd=c×Δt, where c is the speed of light in air. For a Δt value of 3 nanoseconds, the path difference is 9 cm. The sine function of the AoA is equal to the path difference over the antenna separation, sin(AoA)=Δd/d. Evaluating this for a path distance of 9 cm gives an AoA of approximately 1.12 radians. For another example, the signal data indicates that a 2.4 GHz signal was received by antennas 3 and 4 of the phased antenna array 104. The signal was received 2 nanoseconds later at antenna 4, and the phase was shifted by 1 radian. Assume the antennas are 10 cm apart. The phase difference (Δφ) can be converted to path difference (Δd) using Δd=(Δφ·λ)/2π. Where λ is the wavelength. Wavelength can be calculated from (λ)=c/f, where c is the speed of light and f is frequency. Since the frequency is 2.4 GHz, the wavelength is 12.5 cm. Plugging in the wavelength and phase difference gives a path difference of about 2 cm. The sine function of the AoA is equal to the path difference over the antenna separation, sin(AoA)=Δd/d. Evaluating this for a path distance of 2 cm gives an AoA of approximately 0.20 radians. Using multiple methods of calculating the AoA allows the signal processing module 120 to check if all methods agree and, if not, to pick the most reliable method or approximate a value based on the answers of each method. The signal processing module 120 may apply at step 310 Kalman filtering to predict and update the state of tracked objects. The Kalman filter uses a series of measurements observed over time, containing statistical noise and other inaccuracies, to produce estimates of unknown variables. It operates in a two-step process: prediction and update. During the prediction step, the Kalman filter uses the current state estimate to predict the state at the next time step. During the update step, the filter incorporates new measurements to correct the state estimate. This process helps to smooth out the tracking data and provides more accurate estimates of the positions and velocities of tracked objects. The signal processing module 120 may apply at step 312 Joint Probabilistic Data Association (JPDA) to associate measurements with tracks probabilistically. JPDA is used in scenarios where there are multiple potential targets and measurements, and it is not clear which measurement corresponds to which target. The signal processing module 120 may calculate the probabilities of each measurement being associated with each track and updates the tracks based on these probabilities. This method helps to resolve ambiguities and improves the accuracy of tracking in complex environments with multiple signal sources. The signal processing module 120 may remove at step 314 outliers to ensure the accuracy of the tracking data. Outliers are measurements that deviate significantly from the expected values and can distort the tracking results. The signal processing module 120 may use statistical analysis and predefined thresholds to identify and filter out these erroneous data points. By removing outliers, the system 100 improves the reliability and precision of the tracking data, ensuring that accurate and consistent measurements are used in the final tracking calculations. The signal processing module 120 may send at step 316 the finalized signal data to the base module 118. The signal data may include tracking data. This tracking data may include the calculated location of each signal source based on received signals. The data may also include metadata such as confidence level and margin of error. For example, the tracking data may include that a civilian device is at the coordinates (1348 m, 804 m, −52 m) and a vehicle is at the coordinates (141 m, 257 m, −195 m) where the origin (0,0,0) is the location of the wireless base station 102. The signal processing module 120 may return at step 318 to the base module 118.

In addition, or alternatively, the signal processing module 120 may use received signal strength to perform trilateration. Trilateration is an alternative method of determining the position of a signal source by calculating the distances between the source and multiple receiving antennas. Distance estimation can be performed using Angle of Arrival (AoA) data, where known positions of the antennas and the angles of the incoming signal are used to infer the distance. However, a more direct and sometimes more precise method may involve deriving the distance from the difference in signal strength received at two or more antennas. The principle behind this method is based on the inverse relationship between signal strength and distance. As the distance from the signal source to the antenna increases, the signal strength decreases, typically following an inverse-square law or a similar attenuation model depending on the environment. In scenarios where trilateration is implemented, the base station 102 may use at least three antennas to determine the exact location of the signal source. The use of three antennas allows the formation of three independent distance equations, which, when solved simultaneously, may provide a unique intersection point corresponding to the location of the signal source. The received signal strength at each antenna may provide the basis for calculating the respective distances. For example, if the signal at one antenna is stronger by a known percentage compared to another, the ratio of these signal strengths can be used to infer the ratio of the distances. By combining this information with the known physical separation between the antennas, the system 100 can establish a set of nonlinear equations representing the distances from the source to each antenna. The solution involves finding the point where the calculated distances (based on signal strength differences) intersect, which represents the most likely location of the signal source relative to the antenna array. Furthermore, the accuracy of trilateration can be enhanced by incorporating additional antennas, which provide more distance measurements and, consequently, reduce the uncertainty in the position estimate. The use of more antennas allows for the implementation of overdetermined systems, where the additional data can be used to minimize errors and improve the robustness of the location estimation process. Trilateration is particularly advantageous in environments where the AoA measurement might be challenging due to multipath propagation or other interference effects that distort the apparent AoA. Trilateration may be used in place of or in conjunction with triangulation.

In some embodiments, the signal processing module 120 uses a MUSIC (Multiple Signal Classification) algorithm. MUSIC utilizes the eigenvalues and eigenvectors of the covariance matrix of the received signal to estimate AoA with high resolution by searching for peaks in the spatial spectrum. To address complex environments, a Multiple Signal Classification (MUSIC) algorithm can be used. In signal processing problems, the objective is to estimate from past measurements or expectations of measurements from a set of constant values upon which the received signals depend.

FIG. 4 illustrates an example operation of the position module 122. The position module 122 may be initiated at step 400 by the base module 118. The position module 122 may receive at step 402 signal data from the base module 118. The position module 122 may locate at step 404 the position of the wireless base station 102 directly using any internal components of the wireless base station 102. For example, if one of the deployment mechanisms 112 is a GPS beacon, then the GPS data may be used to locate the global position of the wireless base station 102. The wireless base station 102 may also calculate a relative position based on previous positions or in relation to another element. For example, the wireless base station 102 may contain an accelerometer, which can keep track of the acceleration of the wireless base station 102. This acceleration data can be used to calculate the position of the wireless base station 102 after being moved from the command center 136, after being moved from a charging or storage station, or after being dropped from a plane or drone. The position module 122 may use at step 406 the signal data to locate the wireless base station 102. Using the signals from sources with fixed, known positions. For example, suppose the command center 136 transmits a signal, and that signal can reach the wireless base station 102. In that case, the position module 122 can use that signal in the signal data to locate the wireless base station 102 relative to the command center 136. The position module 122 can use multiple signal sources to increase the accuracy of the calculated position. The position module 122 may use the change in position of other signals to calculate the trajectory of the wireless base station 102. The position module 122 may send at step 408 the position of the wireless base station 102 to the base module 118. The position module 122 may return at step 410 to the base module 118.

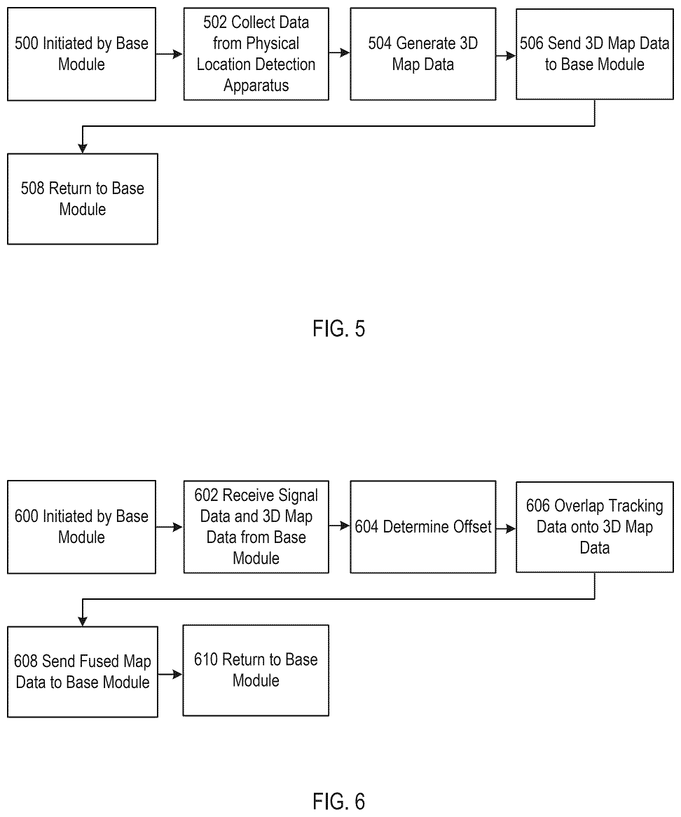

FIG. 5 illustrates an example operation of the mapping module 124. The mapping module 124 may be initiated at step 500 by the base module 118. The mapping module 124 may collect at step 502 data from the physical location detection apparatus 108. The mapping module 124 may generate at step 504 3D map data from the data collected from the physical location detection apparatus 108. Generating 3D map data from Synthetic Aperture Radar (SAR), cameras, and other sensors involves a comprehensive multi-step process that integrates various data types to create accurate and detailed 3D representations of terrain and objects. The mapping module 124 may convert raw SAR signals into usable imagery through steps such as range compression, azimuth compression, and calibration. Optical and infrared images may be rectified to correct geometric distortions and georeferenced to align them with geographic coordinates. This ensures that all data layers correspond to the same locations on the Earth's surface. Noise reduction and filtering techniques may be applied to remove artifacts and enhance data quality, improving the accuracy of subsequent data integration and 3D reconstruction. The mapping module 124 may detect surface structures and textures from SAR data and identify edges, corners, and textures from optical and infrared images. The mapping module 124 may align and combine the different datasets to create a comprehensive representation using techniques like image registration. 3D reconstruction may involve stereo matching techniques on optical images taken from different angles to derive depth information and create 3D point clouds. Photogrammetry measures the geometric properties of objects from photographic images to build 3D models. SAR interferometry (InSAR) uses interferometric techniques with SAR data to measure ground displacement and topography, creating detailed 3D elevation maps. Integrating LiDAR data enhances the 3D reconstruction by providing highly accurate distance measurements that improve the detail and accuracy of the 3D model. The mapping module 124 may remove outliers, fill gaps, and smooth the surface using techniques like filtering, meshing, and interpolation to refine the 3D model. The mapping module 124 may apply textures from optical and infrared images to the 3D model, enhancing visual realism. The mapping module 124 may ensure the accuracy and reliability of the 3D map data by comparing the 3D model against ground truth data or other reliable sources. The mapping module 124 may use visualization tools such as GIS platforms, 3D modeling software, and virtual reality systems to render the final 3D map, allowing for interactive exploration and analysis of the terrain and structures. The mapping module 124 may send at step 506 the 3D map data to the base module 118. The mapping module 124 may return at step 508 to the base module 118.

FIG. 6 illustrates an example operation of the data fusion module 126. The data fusion module 126 may be initiated at step 600 by the base module 118. The data fusion module 126 may receive at step 602 signal data and 3D map data from the base module 118. The data fusion module 126 may determine at step 604 the offset between the origin of the signal data and the origin of the 3D map data. This may correspond to the distance offset between the phased antenna array 104 and the physical location detection apparatus 108. If these components are fixed, then the offset may already be known to the system 100. If the physical location detection apparatus 108 emits a wireless signal, then the offset can be determined from the tracking data in the signal data. The data fusion module 126 may overlap at step 606 the tracking data from the signal data onto the 3D map data. This creates a fused map where the signal sources in the tracking data are placed in their approximate locations in the 3D map. The data fusion module 126 may send at step 608 the fused map data to the base module 118. The data fusion module 126 may return at step 610 to the base module 118.

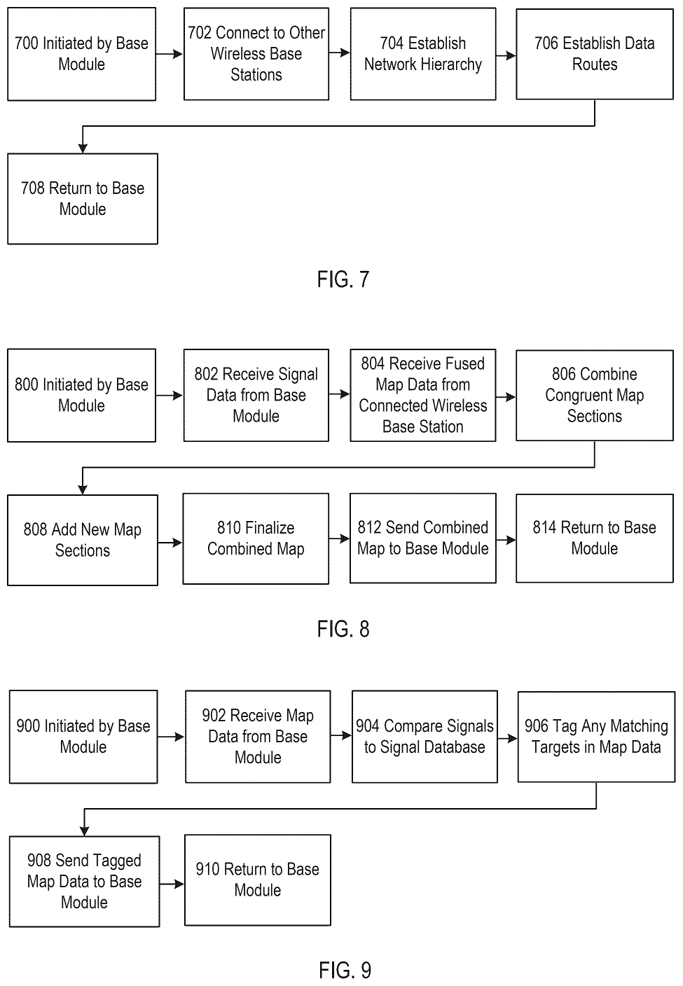

FIG. 7 illustrates an example operation of the mesh module 128. The mesh module 128 may be initiated at step 700 by the base module 118. The mesh module 128 may connect at step 702 to other wireless base stations 102 via the communication interface 110. The mesh module 128 may establish at step 704 a network hierarchy. The network hierarchy determines which wireless base stations 102 hold which positions in the mesh network. This may establish a primary wireless base station 102, which may make decisions for the mesh network. The mesh network may use a traditional hierarchy, flat network, cloud computing hierarchy, or any network hierarchy known in the art. The mesh module 128 may establish at step 706 data routes through the mesh network. These data routes direct data through the mesh network to a target wireless base station 102 or to another receiver such as the command center 136. This allows distant wireless base stations 102 to communicate by relaying signals through intermediate wireless base stations 102. Examples of data route protocols include Ad hoc On-Demand Distance Vector (AODV), Optimized Link State Routing (OLSR), Dynamic Source Routing, Hybrid Wireless Mesh Protocol (HWMP), or any other protocol used to find the optimal paths to send data through the mesh network. The mesh module 128 may return at step 708 to the base module 118.

FIG. 8 illustrates an example operation of the stitching module 130. The stitching module 130 may be initiated at step 800 by the base module 118. The stitching module 130 may receive at step 802 fused map data from the base module 118. The stitching module 130 may receive at step 804 fused map data from other wireless base stations 102 in the mesh network. The stitching module 130 may also send the fused map data to other wireless base stations 102. The stitching module 130 may combine at step 806 any map data from the base module 118 and from other connected wireless base stations 102 that is congruent. Congruent map data may refer to any data that appears on more than one set of fused map data. For example, the fused map data from the base module 118 and the fused map data from another wireless base station 102 may both contain data signals for a cellphone at a similar location and 3D map data that maps the exterior of the same building. However, there may be small differences in the location of the signal or the 3D render of the building due to differing perspectives and sources of error. These congruent sets of data are combined to form one comprehensive set of data. This combination may use the average position of each congruent vector, a weighted average, or some other combination method. For example, if the fused data from the base module 118 has tracking data that shows a vehicle is at the coordinates (141 m, 257 m, −195 m) and the data from another wireless base station 102 has the same vehicle at the vehicle is at the coordinates (145 m, 261 m, −191 m) then the combined data may have the location at the average coordinates (143 m, 259 m, −193 m). Note that the data from the wireless base stations 102 first has to be transformed such that the receiving wireless base station is at the origin (0,0,0) and not the wireless base station 102 that sent the data. This can be done by offsetting the fused map data based on the detected position of the other wireless base station 102. The stitching module 130 may add at step 808 any new map sections. New map sections may refer to any fused map data from another wireless base station 102 for which there is no analog in the fused map data from the base module 118. This may occur when the mapped area is outside the range of one wireless base station, 102, but inside of the range of another. If multiple wireless base stations 102 send congruent new map data, that data may be combined using the method of step 806 before being added to the combined map data. The stitching module 130 may finalize at step 810 the combined fused map data. This finalization step may include a verification process wherein the wireless base stations 102 that are part of the connected mesh network each compare their combined, fused map data to see if they all agree. The mesh network may use a census algorithm, such as Practical Byzantine Fault Tolerance, or may select one or more wireless base stations 102 to determine the final version of the combined fused map data. The stitching module 130 may send at step 812 the combined, fused map data to the base module 118. The stitching module 130 may return at step 814 to the base module 118.

FIG. 9 illustrates an example operation of the target module 132. The target module 132 may be initiated at step 900 by the base module 118. The target module 132 may receive at step 902 fused map data or combined fused map data from the base module 118. The target module 132 may compare at step 904 the signals in the signal data of the fused map data to the signal database 134. The signal database 134 contains signals for known targets or types of targets. The target module 132 may tag at step 906 any matching targets in the map data. For example, the signal data of the map data indicates there is a signal at the coordinates (141 m, 257 m, −195 m). The signal has a carrier frequency of 1 GHz, uses LFM modulation, has a bandwidth of 1 kHz, and appears in short pulses. This matches an entry in the signal database 134 for radar signals, and the target is likely a vehicle. The target module 132 may be able to further narrow down the vehicle type using other data in the map data. For example, using 3D map data, the outline of the vehicle may be detected and recognized. For another example, the position of the vehicle, such as in the air or underwater, may narrow down the vehicle type to land, sea, and/or air. Once the target is identified, the signal and/or position of the target is tagged in the map data. The target module 132 may send at step 908 the tagged map data to the base module 118. The target module 132 may return at step 910 to the base module 118.

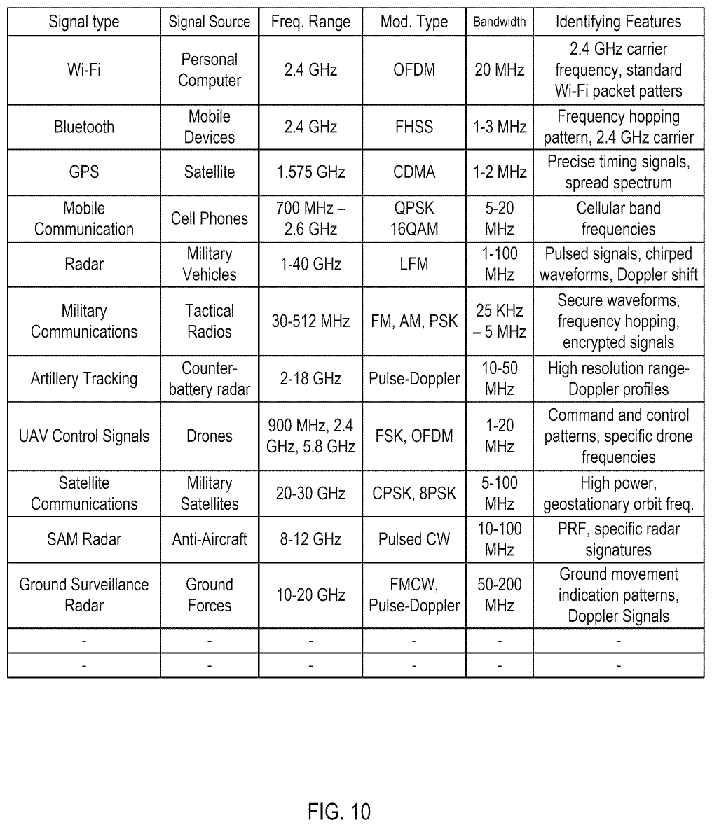

FIG. 10 illustrates an example operation of the signal database 134. The signal database 134 may contain signals for known targets or types of targets. Target types may refer to general assets that have an identifiable signal and would likely be tactical targets, such as artillery, communications, vehicles, etc. Unique targets with unique signals may also be included in the signal database 134, such as the IP of an enemy commander's computer. The signal database 134 may contain a signal type, such as “Radar”; a likely source of that signal, such as vehicles; features of the signal, such as frequency range, modulation type, bandwidth, etc.; and any other identifying features, such as specific pulse repetition frequencies (PRF), chirp signals, Doppler shifts, high-power signals, etc.

Data from the wireless base station 102 may be integrated into existing positioning systems or methods. Dead reckoning is a method used by projectiles to navigate when they cannot rely on external signals. Normally, a projectile might receive guidance from the command center 136 or a fighter jet. If this external source is destroyed or unavailable, the projectile may use dead reckoning to continue on its path. This involves using internal sensors to track its speed, direction, and time traveled based on a previously known position. Modern dead reckoning techniques primarily use inertial sensors, which measure changes in movement. The projectile may calculate its position by combining data on speed, direction, and time elapsed. If a wireless base station 102 is attached to the projectile, it may pick up signals from other devices on the battlefield without actively transmitting anything. Alternatively, an aircraft, vehicle, drone, another projectile, or any other vessel carrying a wireless base station 102 may move through the battlefield, gather signals from various transmitting devices, and send this data back to the projectile. This data helps the projectile to determine its location more accurately by cross-referencing these signals with known positions. The aircraft, vehicle, drone, or other vessel might take flight ahead of the projectile and send processed signal data to the projectile in transmit and/or send the processed signal data to a satellite, aircraft, drone, vehicle, or any other vessel carrying a projectile in order to preload the detected signals and their locations into the projectile to function as part of an enhanced dead reckoning system. The projectile intended to hit a target would have preloaded knowledge of the locations of signal sources and their signatures. It may use that data to help discern its position and how to reposition itself to hit the target.

Another navigation method is TERCOM (Terrain Contour Matching), which uses radar to measure the distance from the ground and compares it with stored terrain maps to estimate the projectile's location. If a wireless base station 102 is attached to the projectile, the system 100 may integrate traditional TERCOM with processed signal data from the wireless base station 102. Alternatively, an aircraft, vehicle, drone, another projectile, or any other vessel carrying a wireless base station 102 may move through the battlefield, gather signals from various transmitting devices, and send this data back to the projectile. This data helps the projectile to determine its location more accurately by cross-referencing these signals with known positions. The aircraft, vehicle, drone, or other vessel might take flight ahead of the projectile and send processed signal data to the projectile in transmit and/or send the processed signal data to a satellite, aircraft, drone, vehicle, or any other vessel carrying a projectile in order to preload the detected signals and their locations into the projectile to function as part of an enhanced TERCOM system. The projectile intended to hit a target would have preloaded knowledge of the locations of signal sources and their signatures. It may use that data to help discern its position and how to reposition itself to hit the target. This combined TERCOM method may be used alongside dead reckoning or as an alternative.

A Quantum Positioning System (QPS) may more precisely determine changes in the projectile's position from its last known state. This is particularly useful when the projectile loses communication with its guiding system. QPS helps the projectile adjust its course to head toward the last known target location. Data from a wireless base station 102 may supplement the QPS data for higher accuracy via error checking and data integration. This information can then be utilized to perform a dead reckoning to determine the position of the projectile.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A system comprising:
a first wireless base station including:
a phased antenna array configured to receive signals from one or more signal sources in an environment;
a signal processing module to determine, based on the signals, a location of each of the one or more signal sources in the environment relative to the phased antenna array;
a position module configured to determine a position of the first wireless base station in the environment;
a physical location detection apparatus including a synthetic aperture radar (SAR), the physical location detection apparatus configured to:
transmit, via the phased antenna array, radar signals into the environment; and
receive, via the phased antenna array, reflected signals from the environment including information about at least one of a distance and a movement of one or more physical objects in the environment;
a mapping module configured to:
collect the information about the at least one of the distance and the movement of the one or more physical objects in the environment from the physical location detection apparatus; and
generate a three-dimensional (3D) spatial map of the environment using the information; and
a data fusion module configured to fuse the 3D spatial map with the location of each of the one or more signal sources to produce a first fused map locating the one or more physical objects and the one or more signal sources in the environment.

2. The system of claim 1, further comprising:
a mesh module configured to connect the first wireless base station and one or more additional wireless base stations via a mesh network by which the first wireless base station and the one or more additional wireless base stations able to share data and relay signals.

3. The system of claim 2, wherein the mesh module is further configured to:
establish a network hierarchy including selection of a primary wireless base station from the first wireless base station and the one or more additional wireless base stations; and
establish one or more data routes through the mesh network to a target wireless base station and/or to a destination system.

4. The system of claim 2, further comprising:
a stitching module configured to combine the first fused map with one or more additional fused maps generated by the one or more additional wireless base stations to generate a cohesive map capable of being shared with a destination system.

5. The system of claim 1, further comprising:
a target module configured to:
identify one or more targets by comparing signal data received by the phased antenna array with a signal database including known targets or types of targets; and
tag identified targets of the one or more targets in the first fused map.

6. The system of claim 1, wherein the signal processing module is configured the location of each of the one or more signal sources using at least one of an Angle of Arrival (AoA) measurement, a Kalman filter, a Joint Probabilistic Data Association (JPDA) operation, and/or a Multiple Signal Classification (MUSIC) algorithm.

7. The system of claim 1, wherein the signal processing module is configured to determine the location of each of the one or more signal sources by triangulation and/or trilateration.

8. The system of claim 1, wherein the signal processing module operates in an active mode by initially pinging the one or more signal sources via the phased antenna array before detecting the signals; or wherein the signal processing module operates in a passive mode by detecting the signals without first pinging the one or more signal sources.

9. The system of claim 1, wherein the position module is configured to use one or more enhancement sensors to determine the position of the first wireless base station.

10. The system of claim 1, wherein the physical location detection apparatus further includes one or more cameras and/or sensors, and wherein data from the one or more cameras and/or sensors is used together with the SAR in generating the 3D spatial map.

11. The system of claim 1, further comprising a quantum positioning system (QPS) configured to navigate a projectile to a last know target location, wherein data from the QPS system is supplemented with data from the wireless base station to increase the accuracy of navigating the projectile.

12. The system of claim 1, further comprising a dead reckoning system that relies on data from the wireless base station to navigate a projectile in the absence of external signals.

13. A method comprising:
receiving, via a phased antenna array of a first wireless base station, signals from one or more signal sources in an environment;
determining, via a signal processor based on the signals, a location of each of the one or more signal sources in the environment relative to the phased antenna array;
determining a position of the first wireless base station in the environment;
transmitting, via the phased antenna array, radar signals into the environment;
receiving, via the phased antenna array, reflected signals from the environment;
determining, using a synthetic aperture radar (SAR), information about at least one of a distance and a movement of one or more physical objects in the environment;
collecting the information about the at least one of the distance and the movement of the one or more physical objects in the environment from the SAR;
generating a three-dimensional (3D) spatial map of the environment using the information;
fusing the 3D spatial map with the location of each of the one or more signal sources to produce a first fused map locating the one or more physical objects and the one or more signal sources in the environment.

14. The method of claim 13, further comprising:
connecting the first wireless base station and one or more additional wireless base stations via a mesh network by which the first wireless base station and the one or more additional wireless base stations able to share data and relay signals.

15. The method of claim 14, wherein connecting includes:
establishing a network hierarchy including selection of a primary wireless base station from the first wireless base station and the one or more additional wireless base stations; and
establishing one or more data routes through the mesh network to a target wireless base station and/or to a destination system.

16. The method of claim 14, further comprising:
combining the first fused map with one or more additional fused maps generated by the one or more additional wireless base stations to generate a cohesive map capable of being shared with a destination system.

17. The method of claim 13, further comprising:
identifying one or more targets by comparing signal data received by the phased antenna array with a signal database including known targets or types of targets; and
tagging identified targets of the one or more targets in the first fused map.

18. The method of claim 13, wherein determining the location of each of the one or more signal sources in the environment relative to the phased antenna array includes using at least one of an Angle of Arrival (AoA) measurement, a Kalman filter, a Joint Probabilistic Data Association (JPDA) operation, and/or a Multiple Signal Classification (MUSIC) algorithm.

19. The method of claim 13, wherein determining the location of each of the one or more signal sources in the environment relative to the phased antenna array includes determine the location of each of the one or more signal sources by triangulation and/or trilateration.

20. The method of claim 13, wherein receiving includes:
actively pinging the one or more signal sources via the phased antenna array before detecting the signals; or
passively detecting the signals without first pinging the one or more signal sources.

21. The method of claim 13, wherein determining the position of the first wireless base station includes using one or more of enhancement sensors to determine the position of the first wireless base station.

22. The method of claim 13, wherein generating the 3D spatial map includes using one or more cameras and/or sensors together with the SAR to generate the 3D spatial map.
